(19) United States
(12) Patent Application Publication
(10) Pub. No.: US 2025/0390523 A1
(43) Pub. Date: Dec. 25, 2025

(54) GAZE-ACTIVATED INFORMATION RETRIEVAL AND SYSTEMS AND METHODS OF USE THEREOF

(71) Applicant: Meta Platforms Technologies, LLC, Menlo Park, CA (US)

(72) Inventors: Melih Altun, San Jose, CA (US); Shih Hsien Wen, Atherton, CA (US); Hao Huang, Milpitas, CA (US); Anthony Diego Draper, Sammamish, WA (US); Wei Wu, Bellevue, WA (US); Hammad Ahsan, Kirkland, WA (US)

(21) Appl. No.: 19/245,199

(22) Filed: Jun. 20, 2025

Related U.S. Application Data
(60) Provisional application No. 63/662,801, filed on Jun. 21, 2024.
(60) Provisional application No. 63/780,072, filed on Mar. 28, 2025.

(51) Int. Cl. G06F 16/3329; G06F 3/01; G06V 40/18

(52) U.S. Cl. CPC G06F 16/33295; G06F 3/013; G06F 3/017; G06V 40/18

(57) ABSTRACT

A method of providing a response to a user based on a field-of-view and a gaze of the user is described. A head-wearable device is communicatively coupled to a non-transitory, computer-readable storage medium including executable instructions that, when executed by one or more processors cause the one or more processors to perform the method. The method includes, causing the one or more cameras of the head-wearable device to capture an image of a field-of-view of the user and causing an eye-tracking device of the head-wearable device to determine a gaze of the user. The method further includes, in response to a capture command, isolating a gaze area of the image from a remainder of the image based on the gaze of the user and identifying, using a machine-learning algorithm, an object in the gaze area. The method further includes generating a response, using another machine-learning algorithm, based on the object.

### RELATED APPLICATION

This application claims priority to U.S. Provisional Application Ser. No. 63/662,801, filed Jun. 21, 2024, entitled “Coplanar Eye-Tracking And Gaze-Activated Information Retrieval And Systems And Method Of Use Thereof,” and U.S. Provisional Application Ser. No. 63/780,072, filed Mar. 28, 2025, entitled “Gaze-Activated Information Retrieval And Systems And Methods Of Use Thereof,” which are incorporated herein by reference.

### TECHNICAL FIELD

This relates generally to information retrieval methods based on eye-tracking data and coplanar eye-tracking configurations for head-worn devices.

### BACKGROUND

Current eye-tracking technology utilizes rings of LEDs and cameras that are used to track eyes with either purely geometrical computer vision (CV), hybrid CV and machine learning (ML), or purely ML based algorithms. However, much of these systems are designed with stringent tracking accuracy for applications such as artificial reality (AR)/virtual reality (VR) displays, user interaction, user experience, or graphics interaction. To achieve accuracy, often head-worn devices will include two cameras, one on the temporal side and one on the nasal side, per-eye which increases the cost for each device. Additionally, the rings of LEDs and cameras, with typically have high refresh rates, increases the power draw of current head-worn devices.

With the advent of artificial intelligence (AI) becoming more available devices such as smart glasses and phones, the landscape for eye tracking changes and a new pathway opens. This allows for new designs to be implemented specifically for eye-tracking-enhanced CAI applications and additional experiences that bring AI to forefront with the user of head-worn devices. However, with the wide field-of-view of front-facing cameras on smart glasses, the scene captured by the head-worn device can be complex with multiple objects and various contexts. The user might be interested in a particular segment or object in the scene, a CAI application might miss a detail the user is focused on, and/or there can be several back and forth between the user and the CAI application until it figures out which part of the image to interpret. Moreover, processing large images can cause noticeable processing overhead, and delayed responses can negatively affect overall user experience.

As such, there is a need to address one or more of the above-identified challenges. A brief summary of solutions to the issues noted above are described below.

### SUMMARY

One example method for providing a response to a user based on a field-of-view and a gaze of the user, in accordance with some embodiments, is described herein. This example method occurs at a head-wearable device, while a user wears the head-wearable with one or more cameras and/or one or more eye-tracking devices. The head-wearable device is communicatively coupled to and/or includes a non-transitory, computer-readable storage medium including executable instructions that, when executed by one or more processors cause the one or more processors to perform the method. In some embodiments, the method includes, causing the one or more cameras of the head-wearable device to capture an image of a field-of-view of the user. The method further includes causing an eye-tracking device of the head-wearable device to determine a gaze of the user. The method further includes, in response to a capture command (e.g., a voice command), isolating a gaze area of the image from a remainder of the image based on the gaze of the user. The method further includes identifying, using a machine-learning algorithm (e.g., a multi-modal AI), an object in the gaze area. The method further includes generating a response, using another machine-learning algorithm (e.g., the multi-modal AI), based on the object.

An example head-wearable device for determining a gaze of the user, in accordance with some embodiments, is also described herein. This example head-wearable device comprises: (i) one or more processors, (ii) memory including instructions that, when executed by the one or more processors, determine a gaze of the user using at least one machine-learning algorithm, and (iii) two groups of illumination sources, each group of illumination sources configured to illuminate the respective eye of the user. A first camera and a first group of illumination sources are located on a first circuit. The first camera and the first group of illumination sources are coplanar, and the first camera and the first group of illumination sources are located on a nasal portion of the head-wearable device.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The devices and/or systems described herein can be configured to include instructions that cause the performance of methods and operations associated with the presentation and/or interaction with an extended-reality (XR) headset. These methods and operations can be stored on a non-transitory computer-readable storage medium of a device or a system. It is also noted that the devices and systems described herein can be part of a larger, overarching system that includes multiple devices. A non-exhaustive of list of electronic devices that can, either alone or in combination (e.g., a system), include instructions that cause the performance of methods and operations associated with the presentation and/or interaction with an XR experience include an extended-reality headset (e.g., a mixed-reality (MR) headset or a pair of augmented-reality (AR) glasses as two examples), a wrist-wearable device, an intermediary processing device, a smart textile-based garment, etc. For example, when an XR headset is described, it is understood that the XR headset can be in communication with one or more other devices (e.g., a wrist-wearable device, a server, intermediary processing device) which together can include instructions for performing methods and operations associated with the presentation and/or interaction with an extended-reality system (i.e., the XR headset would be part of a system that includes one or more additional devices). Multiple combinations with different related devices are envisioned, but not recited for brevity.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIG. 1 illustrates an example of an artificially intelligent (AI) assistant retrieving information for a user based on a field-of-view of the user, a gaze of the user, and a voice command performed by the user, in accordance with some embodiments.

FIG. 2 illustrates a flow diagram of a method for retrieving information for the user based on the field-of-view, the gaze, and the voice command, in accordance with some embodiments.

FIGS. 3A-3F illustrate an example of the AI assistant identifying objects in the field-of-view based on the gaze, in accordance with some embodiments.

FIG. 4 illustrates another flow diagram of a method for retrieving information for the user based on the field-of-view of the user, the gaze of the user, and the voice command of the user, in accordance with some embodiments.

FIGS. 5A-5E illustrate example configurations for a circuit board including a camera for capturing image data of an eye of a user and at least one illumination source for illuminating the eye of the user and/or an area around the eye of the user, in accordance with some embodiments.

FIGS. 6A-6B illustrates images of the eye of the user taken with different illumination source configurations and while the user is gazing in different directions, in accordance with some embodiments.

FIG. 7 shows an example method flow chart for of providing a response to a user based on a field-of-view and a gaze of the user, in accordance with some embodiments.

FIGS. 8A, 8B, 8C-1, and 8C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

A gaze gesture, as described herein, can include an eye movement and/or a head movement indicative of a location of a gaze of the user, an implied location of the gaze of the user, and/or an approximated location of the gaze of the user, in the surrounding environment, the virtual environment, and/or the displayed user interface. The gaze gesture can be detected and determined based on (i) eye movements captured by one or more eye-tracking cameras (e.g., one or more cameras positioned to capture image data of one or both eyes of the user) and/or (ii) a combination of a head orientation of the user (e.g., based on head and/or body movements) and image data from a point-of-view camera (e.g., a forward-facing camera of the head-wearable device). The head orientation is determined based on IMU data captured by an IMU sensor of the head-wearable device. In some embodiments, the IMU data indicates a pitch angle (e.g., the user nodding their head up-and-down) and a yaw angle (e.g., the user shaking their head side-to-side). The head-orientation can then be mapped onto the image data captured from the point-of-view camera to determine the gaze gesture. For example, a quadrant of the image data that the user is looking at can be determined based on whether the pitch angle and the yaw angle are negative or positive (e.g., a positive pitch angle and a positive yaw angle indicate that the gaze gesture is directed toward a top-left quadrant of the image data, a negative pitch angle and a negative yaw angle indicate that the gaze gesture is directed toward a bottom-right quadrant of the image data, etc.). In some embodiments, the IMU data and the image data used to determine the gaze are captured at a same time, and/or the IMU data and the image data used to determine the gaze are captured at offset times (e.g., the IMU data is captured at a predetermined time (e.g., 0.01 seconds to 0.5 seconds) after the image data is captured). In some embodiments, the head-wearable device includes a hardware clock to synchronize the capture of the IMU data and the image data. In some embodiments, object segmentation and/or image detection methods are applied to the quadrant of the image data that the user is looking at.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography (ECG or EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Gaze-Activated Information Retrieval & Coplanar Eye Tracking

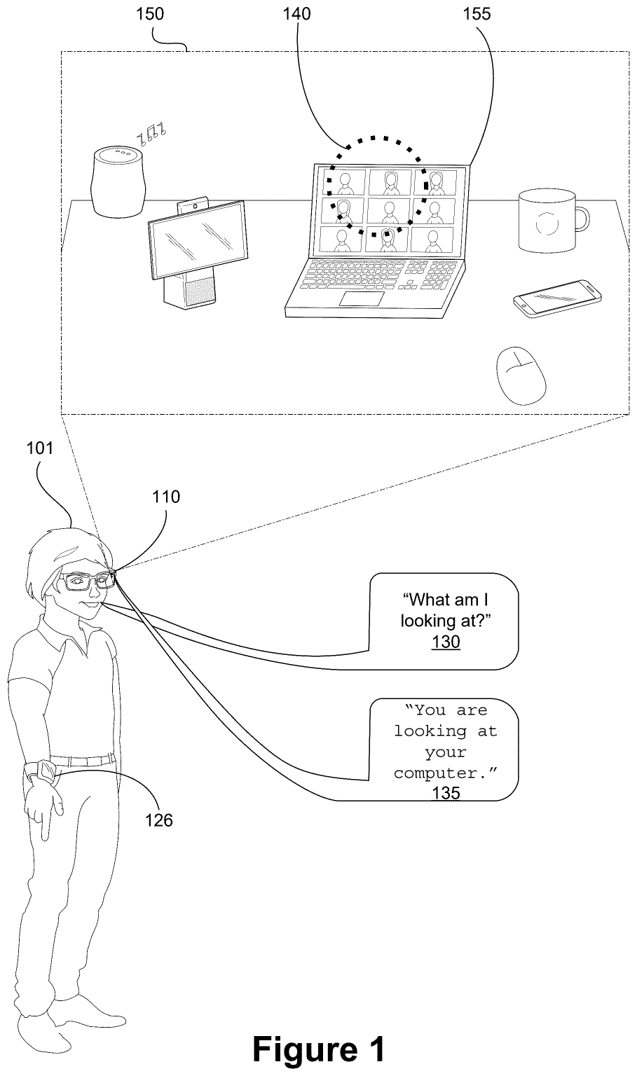

FIG. 1 illustrates an example of an artificially intelligent (AI) assistant retrieving information for a user 101 based on a field-of-view 150 of the user 101, a gaze 140 (e.g., a gaze gesture toward a location in the field-of-view 150) of the user 101, and a voice command 130 performed by the user 101, in accordance with some embodiments. The field-of-view 150 is captured by one or more imaging devices (e.g., a front-facing camera) of a head-wearable device 110 (e.g., an XR headset, a pair of smart glasses, and/or smart contacts). The gaze 140 is captured by one or more eye-tracking cameras of the head-wearable device 110, and/or the gaze 140 is determined based on a head orientation of the user 101 and the field-of-view 150. In some embodiments, the head orientation of the user 101 is determined based on inertial measurement unit (IMU) data captured by one or more IMU sensors of the head-wearable device 110. The voice command 130 is captured by one or more microphones of the head-wearable device 110 and/or one or more microphones of another device (e.g., a smartphone, a handheld intermediary processing device, a wrist-wearable device 115, and/or another wearable device) communicatively coupled to the head-wearable device 110. In some embodiments, the AI assistant retrieving information for the user 101 is further based on additional contextual information (e.g., calendar information, weather information, location information, user settings information, etc.). In some embodiments, the AI assistant is a multimodal artificial intelligence including one or more of a language-learning model (LLM), computer vision, audio processing, deep learning, and generative artificial intelligence.

In some embodiments, the AI assistant retrieving information for the user 101 includes identifying an object of focus 155 (e.g., a computer) in the field-of-view 150 based on the gaze 140 (e.g., identifying an object that the user 101 is gazing at, as illustrated in FIG. 1). In some embodiments, the object of focus 155 is further determined based on the voice command 130 and/or the additional contextual information from other input devices. In some embodiments, the AI assistant determines one or more tasks (e.g., inform the user 101 what they are looking at) to be performed based on the object of focus 155, the voice command 130 (e.g., “What am I looking at?”), and/or the additional contextual information (e.g., obtained at one or more touch-input devices, one or more buttons, one or more cameras, and/or one or more haptic devices)). In some embodiments, the AI assistant performs the one or more tasks, and/or the AI assistant sends an instruction to perform the one or more tasks to an additional device and/or one or more other processors which then performs the one or more tasks. In some embodiments, the AI assistant retrieving information for the user 101 includes generating and presenting a response 135 (e.g., “You are looking at your computer.”), based on the one or more tasks, to the user 101. In some embodiments, the response 135 is a visual response presented at one or more displays of the head-wearable device 110 and/or one or more displays of the other device, and/or the response 135 is an audio response presented at one or more speakers of the head-wearable device 110 and/or one or more speakers of the other device.

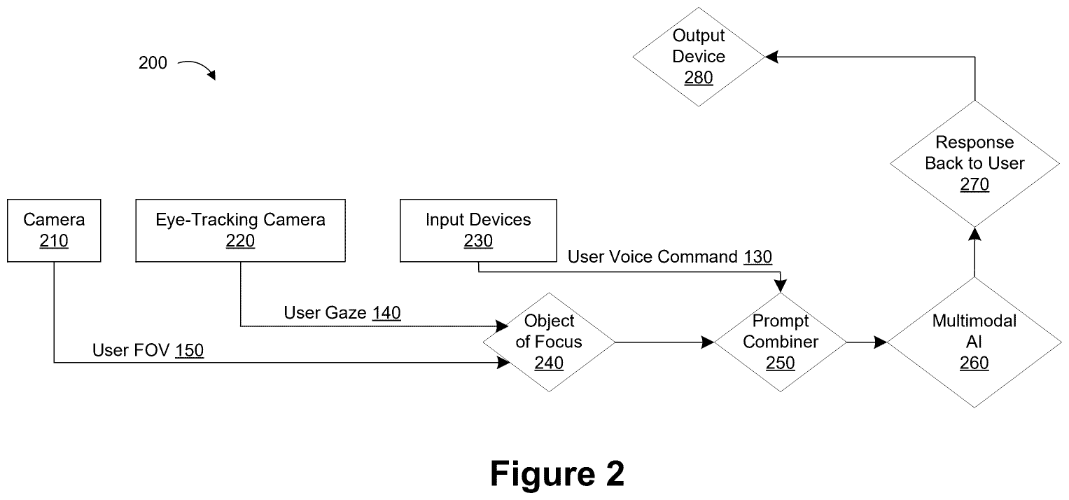

FIG. 2 illustrates a flow diagram of a method 200 for retrieving information for the user based on the field-of-view 150, the gaze 140, and the voice command 130, in accordance with some embodiments. In some embodiments, the method 200 is performed at one or more processors. In some embodiments, the head-wearable device 110 includes the one or more processors, the other device includes the one or more processors, and/or the one or more processors are communicatively coupled to the head-wearable device 110 and/or the other device (e.g., the one or more processors are at a server communicatively coupled to the head-wearable device 110 by a cellular network). The method 200 includes receiving, at the one or more processors and from the head-wearable device 110 and/or the other device: (i) the field-of-view 150 (e.g., as illustrated in FIG. 1) from the one or more imaging devices 210 of the head-wearable device 110, (ii) the gaze 140 (e.g., as illustrated in FIG. 1) from the one or more eye-tracking cameras 220, and (iii) the voice command 130 (e.g., “What am I looking at?”) from the one or more input devices 230 (e.g., one or more microphones, one or more touch-input devices, one or more buttons, one or more cameras, and/or one or more haptic devices). The method 200 further includes determining the object of focus 155 (e.g., a computer, as illustrated in FIG. 1) based on the field-of-view 150 and the gaze 140 (240). In some embodiments, the method 200 further includes determining two or more objects of focus based on the field-of-view 150 and the gaze 140. The method 200 further includes combining the object of focus 155 (and/or the two or more objects) and the voice command 130 into a prompt (250) (e.g., “What object/item/person/animal/plant/building is at the gaze location within this image”). The method 200 further includes providing the prompt to the AI assistant, and the AI assistant determines the one or more tasks based on the prompt (260). In some embodiments, the AI assistant generates the response 135 based on the one or more tasks, and/or sends the instruction to perform the one or more tasks to the additional device and/or the one or more other processors. In some embodiments, the AI assistant generates two or more responses based on each of the two or more objects. The method 200 further includes sending the response 135 (e.g., “You are looking at your computer.”) (and/or the two or more responses) to an output device (e.g., the head-wearable device 110 and/or the other device) associated with the user 101 (270). The method 200 further includes presenting the response 135 (and/or the two or more responses) to the user 101 at the output device (280) (e.g., a visual response and/or an audio response).

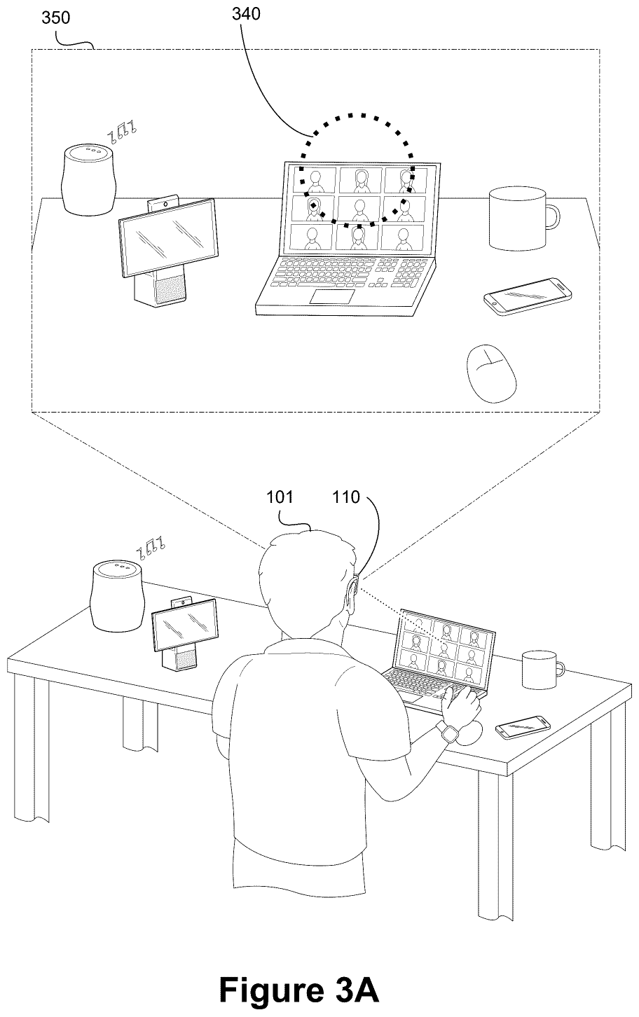

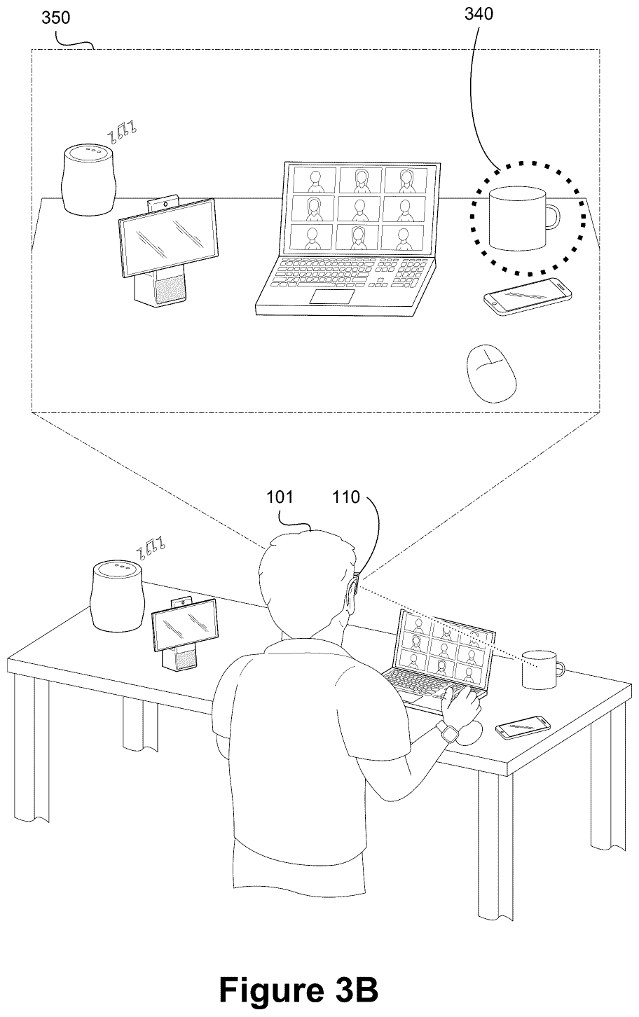

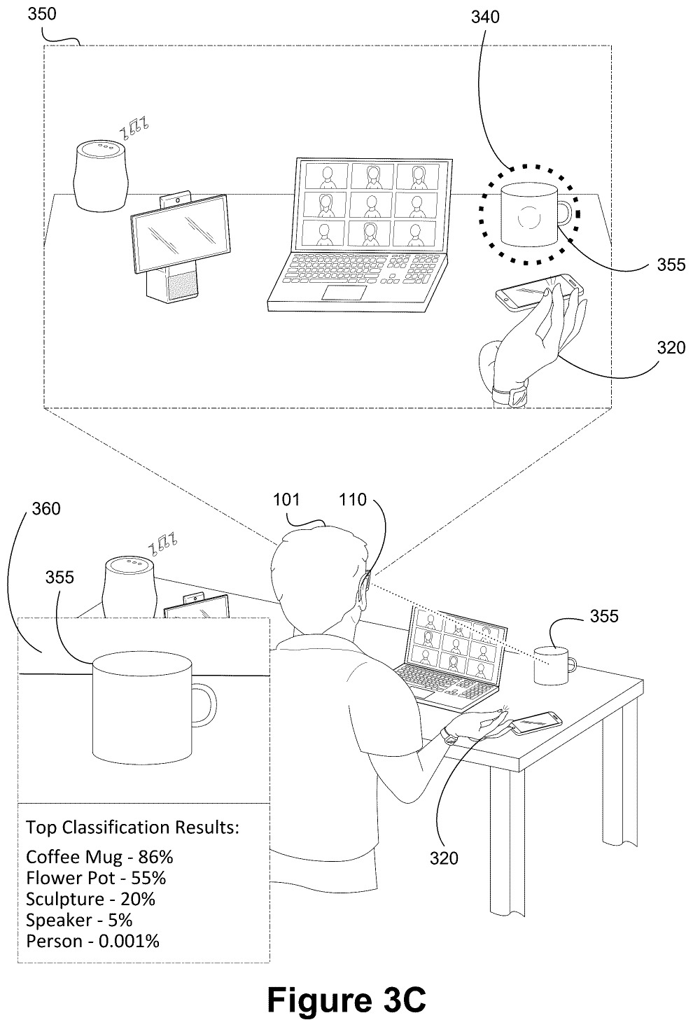

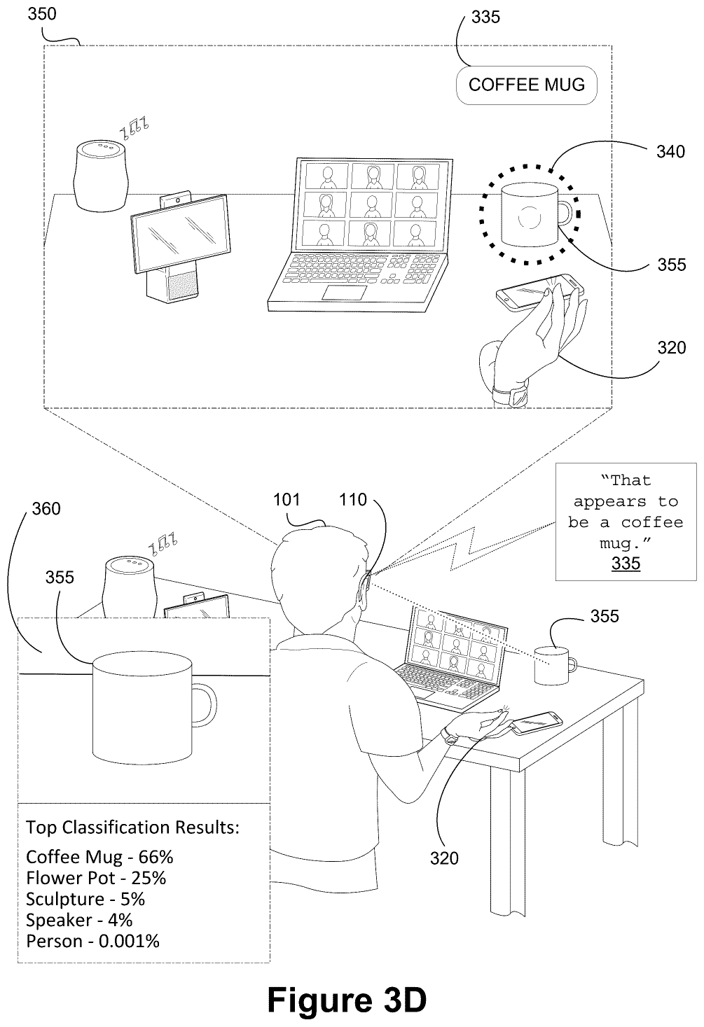

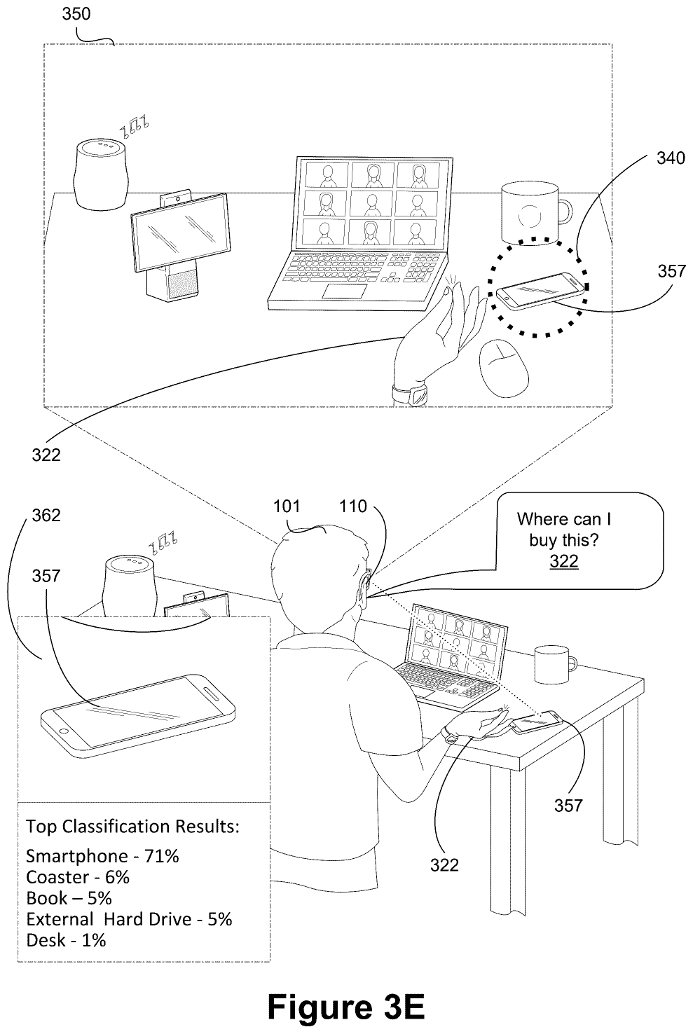

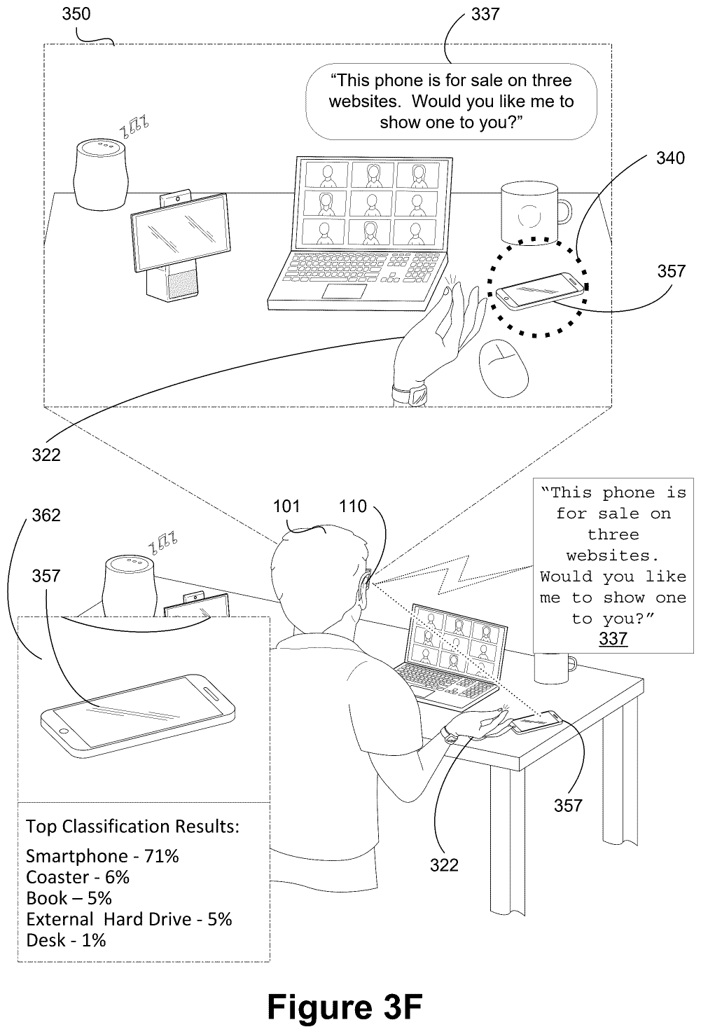

FIGS. 3A-3F illustrate an example of the AI assistant identifying objects in the field-of-view 150 based on the gaze 140, in accordance with some embodiments. FIG. 3A illustrates the field-of-view 350 of the user 101 targeting objects in the field-of-view 350 with the gaze 340, in accordance with some embodiments. In some embodiments, the one or more imaging devices begins capturing the field-of-view 350 and/or the one or more eye tracking cameras begins capturing the gaze 340 in response to a user wake input (e.g., a voice command, such as “What am I looking at?” a hand gesture, such as a finger-pinch hand gesture, and/or a touch input, such as the user 101 touching a side of the head-wearable device 110). In some embodiments, the display of the head-wearable device 110 presents a gaze indicator to the user 101 at a location of the gaze 340. FIG. 3B illustrates the gaze 340 changing location as the user 101 moves their eyes and/or head, in accordance with some embodiments. In some embodiments, as the gaze 340 changes, the gaze indicator changes location to match the location of the gaze 340.

FIG. 3C illustrates the AI assistant determining the object of focus 355 (e.g., an apple) based on image data of the field-of-view 350 captured by the one or more imaging devices, in accordance with some embodiments. In some embodiments, the AI assistant determines the object of focus 355 (e.g., a coffee mug) in response to a user capture input 320 (e.g., a voice command, such as “What is this?” a hand gesture, such as a double finger-pinch hand gesture, and/or a touch input, such as the user 101 touching another side of the head-wearable device 110). In some embodiments, the AI Assistant determines the object of focus 355 based on a portion of the image data 360, based on the gaze 340. In some embodiments, the AI Assistant determines the object of focus 355 based on the image data and the location of the gaze 340 rather than the portion of the image data 360. For example, in response to the user capture input 320, the image data of the field-of-view 350 is cropped to the portion of the image data 360, which is a portion proximate to the gaze 340. The AI assistant uses computer vision to determine the object of focus 355 based on the portion of the image data 360. In some embodiments, determining the object of focus 355 includes determining respective probabilities that the object of focus 355 is a respective identifiable object. For example, in response to the user 101 targeting the object of focus 355 with the gaze 340, the AI assistant determines that the object of focus 355 is most likely a coffee mug based on a determination that the object of focus 355 is 66% likely to be a coffee mug, 25% likely to be a flower pot, 5% likely to be a sculpture, 4% likely to be a speaker, 0.001% likely to be a person, etc., as illustrated in FIG. 3C. FIG. 3D illustrates the AI assistant providing a response 335 to the user 101 based on the object of focus 355, as determined by the AI assistant, and the user capture input 320, in accordance with some embodiments. For example, the response 335 is determined to be “That appears to be a coffee mug.” since the AI assistant determined that the object of focus 355 is an apple and the user capture input 320 was “What is this?” and/or a double finger-pinch hand gesture. The head-wearable device 110 and/or the other device presents the response 335 to the user 101 (e.g., as an audio response presented at the one or more speakers of the head-wearable device 110 and/or a visual response presented at the one or more displays of the head-wearable device 110 and/or the one or more displays of the other device).

FIGS. 3E-3F illustrate another example of the AI assistant determining another object of focus 357 and providing another response 337 in response to another user capture input 322, in accordance with some embodiments. FIG. 3E illustrates the user 101 performing the other capture input 322 (e.g., a voice command “Where can I buy this?” and/or another double finger pinch gesture) while targeting the other object of focus 357 (e.g., a computer mouse) in the field-of-view 350 with the gaze 340. In response to the other capture input 322, the image data of the field-of-view 350 is cropped to another portion of the image data 362 proximate to the gaze 340. The AI assistant uses computer vision to determine the other object of focus 357 based on the other portion of the image data 362 by determining other respective probabilities that the other object of focus 357 is another respective identifiable object (e.g., the AI assistant determines that the other object of focus 357 is most likely a computer mouse based on a determination that the other object of focus 357 is 71% likely to be a smartphone, 6% likely to be a coaster, 5% likely to be a book, 5% likely to be an external hard drive, 1% likely to be a desk, etc., as illustrated in FIG. 3E). FIG. 3F illustrates the AI assistant providing another response 337 to the user 101 based on the other object of focus 357, as determined by the AI assistant, and the other user capture input 322. The AI assistant determines the other response 337 to be “This phone is for sale on three computer parts websites. Would you like me to show one to you?” since the AI assistant determined that the other object of focus 357 is a computer mouse and the other user capture input 322 was “Where can I buy this?” The head-wearable device 110 and/or the other device presents the other response 337 to the user 101 (e.g., as an audio response presented at the one or more speakers of the head-wearable device 110 and/or a visual response presented at the one or more displays of the head-wearable device 110 and/or the one or more displays of the other device).

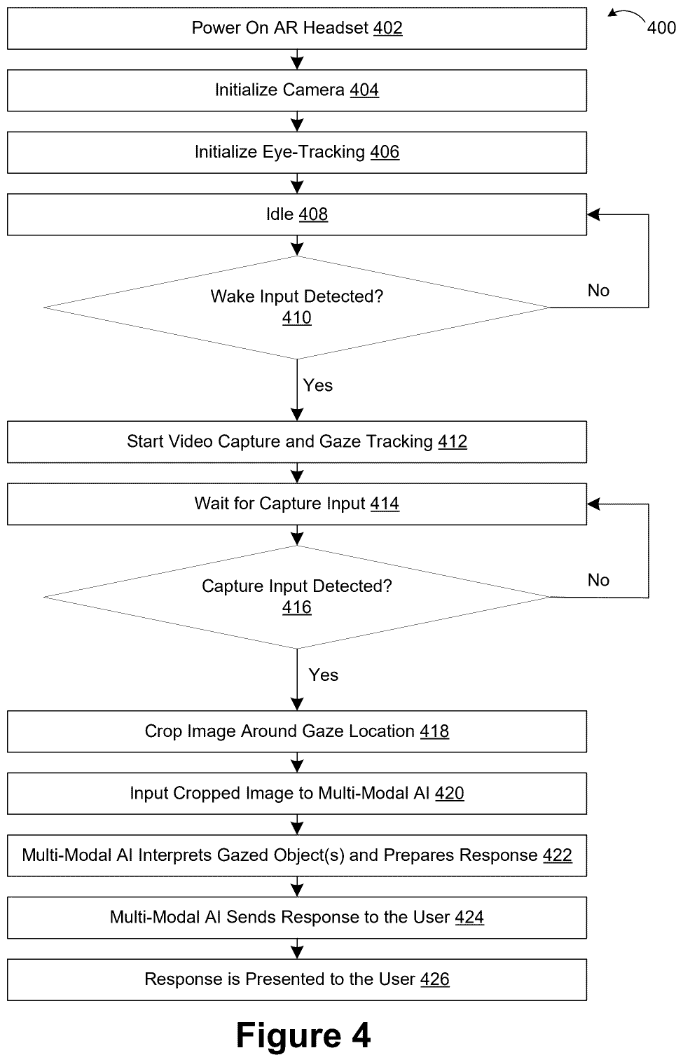

FIG. 4 illustrates another flow diagram of a method 400 for retrieving information for the user 101 based on the field-of-view (e.g., the field of view 150 and/or the field of view 350) of the user 101, the gaze (e.g., the gaze 140 and/or the gaze 340) of the user 101, and the voice command (e.g., the voice command 130, the user capture input 320, and/or the other user capture input 322) of the user 101, in accordance with some embodiments. The method 400 begins when the head-wearable device 110 is powered on (402) and initializes a point-of-view camera (e.g., the forward-facing camera) (404) and an eye-tracking camera (406). After initializing the point-of-view camera and the eye-tracking camera, the head-wearable device 110 idles and waits for a user wake input (408). In response to detecting the user wake input (e.g., a voice command, a hand gesture, and/or a touch input) (410), the point-of-view camera captures image data (e.g., video data) of the field-of-view of the user 101 and the eye-tracking camera captures the gaze of the user 101 (412). The point-of-view camera continues to capture image data of the field-of-view of the user 101 until a capture input is detected (414). In response to detecting the capture input (416), the head-wearable device 110 determines a portion of the image data of the field-of-view of the user 101 that is associated with the gaze (e.g., the gaze 140) of the user 101 (e.g., a portion of the image data that is proximate to the gaze). In response to a capture command (e.g., a button press and/or a voice command), the head-wearable device crops the portion of the image data of the field-of-view of the user 101 that is associated with the gaze of the user 101 to create cropped image data (418). The cropped image data is then sent to a multi-modal AI (e.g., the AI assistant) (420). The multi-modal AI processes the cropped image data and identifies an object (e.g., the object of focus 155) in the portion of the image data of the field-of-view of the user 101 that is associated with the gaze of the user 101 (422). In some embodiments, the multi-modal AI further prepares a response to a query based on the object and the capture input. The multi-modal AI then sends the response to an output device of the head-wearable device 110 (424), and the output device presents the response to the user 101 (426).

The above method can be used to enhance user interaction with a multi-modal AI assistant using gaze tracking technology in conjunction with the head-wearable device 110. This approach addresses challenges associated with the wide field of view cameras on head-wearable devices, which often capture complex scenes with multiple objects and various contexts. The proposed system addresses such problems by focusing on the user's gaze location. It employs an eye tracking system, embedded within the head-wearable device 110. The eye tracking system may include electro-optical components such as an IR emitter and ultra-compact cameras, concealed within a frame or a lens of the head-wearable device 110. Upon activation of a gaze tracking mode, either through an application or a voice command, the system captures a snapshot of the user's field of view. The system then crops the image to focus on the area around the user's gaze location. This cropped image, representing the gazed object, is sent to the multi-modal AI assistant for processing. The AI assistant attempts to identify the gazed object and retrieve relevant information about it. This method improves the relevancy and reduces the latency of the AI assistant's responses, thereby enhancing the overall user experience. This is unique in its integration of gaze tracking technology with a multi-modal AI assistant in a head-wearable device. This method provides a more targeted and efficient way of interpreting scenes compared to existing solutions. This method can be extended to a variety of head-wearable devices such as smart glasses, AR glasses, VR headsets, etc. Furthermore, this method can be applied to related fields such as augmented reality, virtual reality, assistive technology, education, healthcare, retail, tourism, automotive industry, security and law enforcement, gaming and entertainment, real estate, and manufacturing and repair.

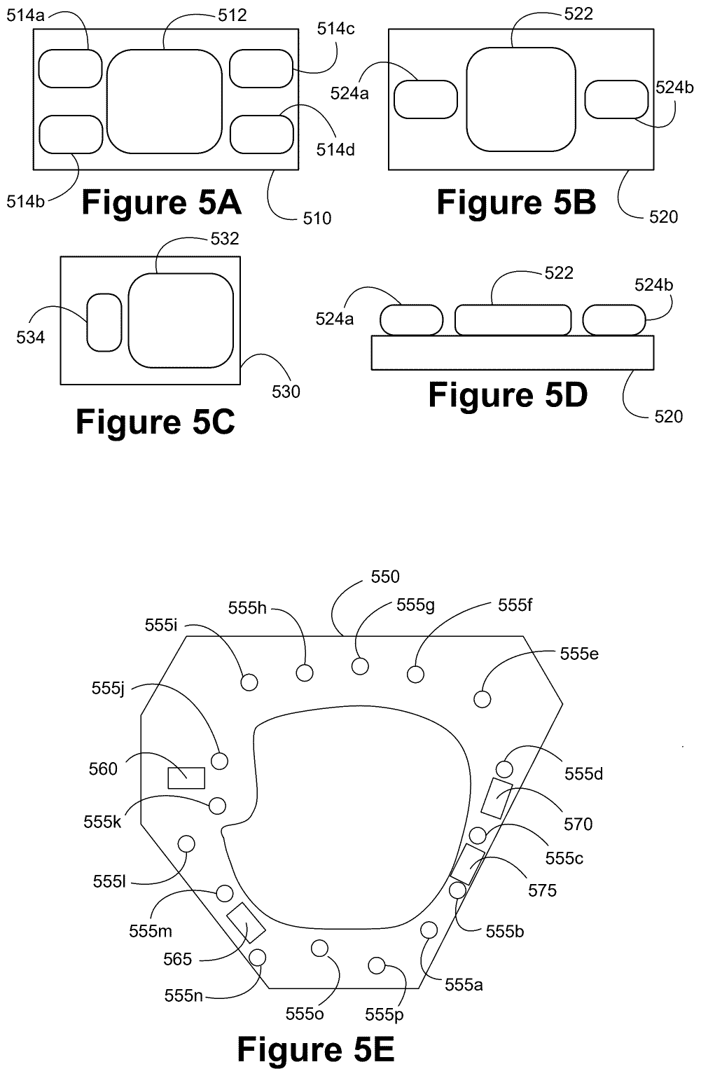

FIGS. 5A-5D illustrate example configurations for a circuit board (e.g., a flexible circuit board) including a camera for capturing image data of an eye of a user and at least one illumination source (e.g., one or more LEDs) for illuminating the eye of the user and/or an area around the eye of the user, in accordance with some embodiments. The example configurations for the circuit board are configured to be mounted on a head-wearable device (e.g., a pair of smart glasses, an augmented-reality (AR) headset, a virtual-reality (VR) headset, etc.) such that the circuit can be used for eye-tracking of the user of the head-wearable device. FIG. 5A illustrates a 4-light configuration with four illumination sources 514a-514d and a first camera 512 on a first circuit board 510, in accordance with some embodiments. FIG. 5B illustrates a 2-light configuration with two illumination sources 524a-524b and a second camera 522 on a second circuit board 520, in accordance with some embodiments. FIG. 5C illustrates a 1-light configuration with one illumination source 534 and a third camera 532 on a third circuit board 530, in accordance with some embodiments. FIG. 5D illustrates a side-view of the second circuit board 520 (e.g., as illustrated in FIG. 5B), in accordance with some embodiments.

FIG. 5E illustrates an example rim portion 550 of a head-wearable device (e.g., the head-wearable device 110), in accordance with some embodiments. The example rim portion includes sixteen possible locations (e.g., positions 555a-555p) for mounting an illumination source and/or the first board 510, the second circuit board 520, and/or the third circuit board 530 for illuminating the eye of the user and four possible locations (e.g., a first temporal position 560, a first nasal position 570, a second temporal position 565, and/or a second nasal position 575) for mounting a camera for capturing image data of the eye of the user. The right side of the example rim portion is adjacent to a nose of the user when the head-wearable device is worn by the user.

Including the camera and the at least one illumination source on one circuit board minimizes the number of components to a single nasal camera per-eye with a number of illumination sources placed coplanar to the camera. By reducing the components, the cost and complexity per-product is reduced. Having the illumination sources on the same circuit board as the camera module further reduces the cost and complexity as there doesn't need to be a completely different circuit board fabricated and integrated into the head-wearable device as the components can be integrated at the same time as the camera. By utilizing machine learning, the illumination requirement is relaxed and instead of relying heavily on glints on the eye, a uniform illumination becomes more important. Furthermore, the accuracy of the eye-tracking does not need to be as demanding, decreasing the machine learning training requirements and increasing the robustness of the eye-tracking.

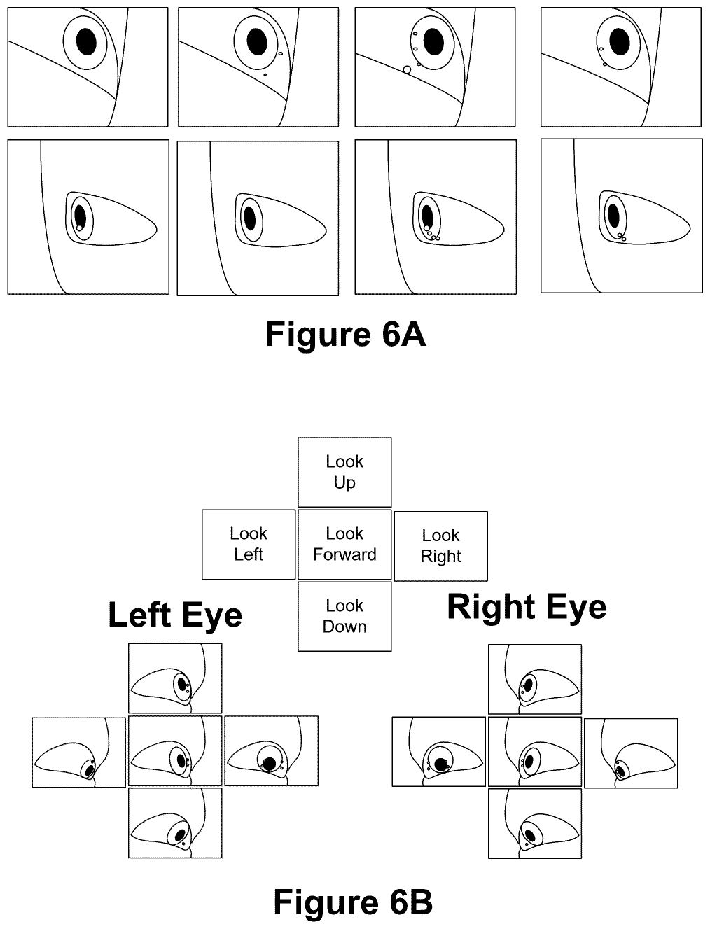

FIG. 6A illustrates images of the eye of the user taken with different illumination source configurations, in accordance with some embodiments. The top row of images are taken from a nasal location (e.g., the first nasal position 570, as labelled in FIG. 5E) and are taken with the following illumination source configurations (from left to right): one illumination source at a nasal position (e.g., the 555b position, as labelled in FIG. 5E), one illumination source at a temporal position (e.g., the 555j position, as labelled in FIG. 5E), four illumination sources at nasal positions (e.g., the 555a-555d positions, as labelled in FIG. 5E), and two illumination sources at nasal positions (e.g., the 555a-555b positions, as labelled in FIG. 5E). The bottom row of images are taken from a temporal location (e.g., the first temporal position 560, as labelled in FIG. 5E) and are taken with the following illumination source configurations (from left to right): one illumination source at a nasal position (e.g., the 555b position, as labelled in FIG. 5E), one illumination source at a temporal position (e.g., the 555j position, as labelled in FIG. 5E), four illumination sources at nasal positions (e.g., the 555a-555d positions, as labelled in FIG. 5E), and two illumination sources at nasal positions (e.g., the 555a-555b positions, as labelled in FIG. 5E). Reflections of light (e.g., as illustrated in FIG. 6A) from the illuminations sources reflect off of an eye of a user, and an eye-tracking system may use the locations of the reflections relative to a pupil of the eye to determine one or more gaze locations of a user's gaze.

FIG. 6B illustrates images of each eye of the user while the user is gazing in different directions, in accordance with some embodiments. The left set of images are images taken of a left eye of the user from a nasal position (e.g., the first nasal position 570, as labelled in FIG. 5E), and the right set of images are images take of a right eye of the user from a nasal position (e.g., the first nasal position 570, as labelled in FIG. 5E). The top image of each set is an image of a respective eye of the user while the user gazes up. The right image of each set is an image of the respective eye of the user while the user gazes to the right. The bottom image of each set is an image of the respective eye of the user while the user gazes down. The left image of each set is an image of the respective eye of the user while the user gazes to the left. The center image of each set is an image of the respective eye of the user while the user gazes straight ahead.

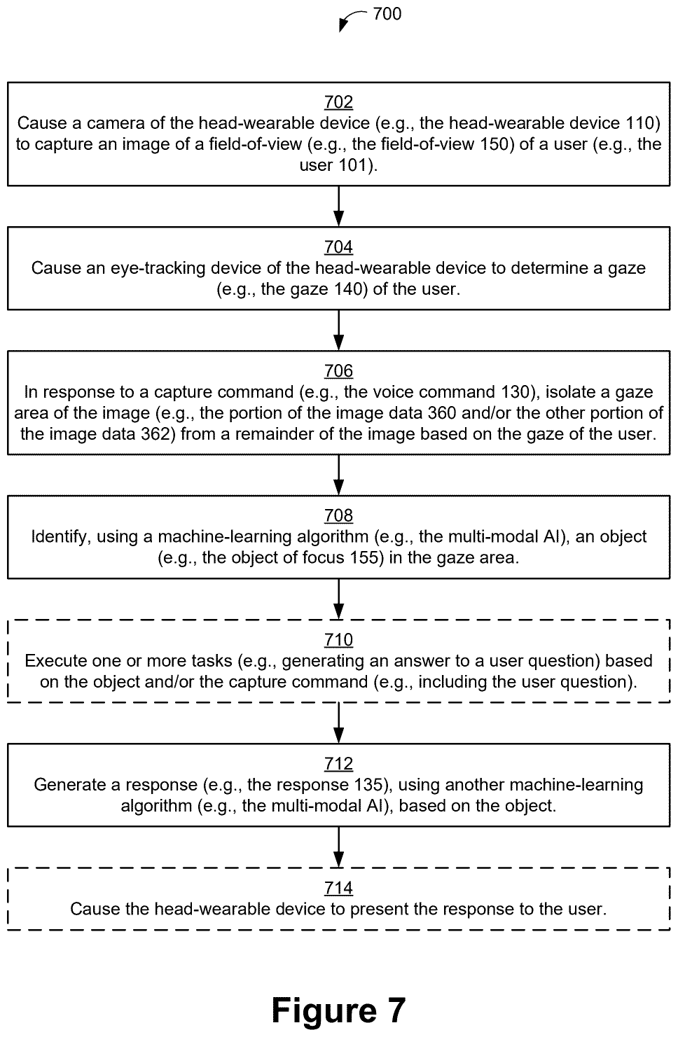

FIG. 7 illustrates a flow diagram of a method of providing a response to a user (e.g., the user 101) based on a field-of-view (e.g., 140) and a gaze (e.g., the gaze 130) of the user, in accordance with some embodiments. Operations (e.g., steps) of the method 700 can be performed by one or more processors (e.g., central processing unit and/or MCU) of a head-wearable device (e.g., the head-wearable device 110) and/or another device communicatively coupled to the head-wearable device. At least some of the operations shown in FIG. 7 correspond to instructions stored in a computer memory or computer-readable storage medium (e.g., storage, RAM, and/or memory) of the head-wearable device and/or the other device. Operations of the method 700 can be performed by a single device alone or in conjunction with one or more processors and/or hardware components of another communicatively coupled device (e.g., a server device, a handheld intermediary processing device, a smartphone, a personal computer, etc.) and/or instructions stored in memory or computer-readable medium of the other device communicatively coupled to the head-wearable device. In some embodiments, the various operations of the methods described herein are interchangeable and/or optional, and respective operations of the methods are performed by any of the aforementioned devices, systems, or combination of devices and/or systems. For convenience, the method operations will be described below as being performed by particular component or device but should not be construed as limiting the performance of the operation to the particular device in all embodiments.
(A1) The method 700 occurs at a head-wearable device, while a user wears the head-wearable with one or more cameras and/or one or more eye-tracking devices. The head-wearable device is communicatively coupled to and/or includes a non-transitory, computer-readable storage medium including executable instructions that, when executed by one or more processors cause the one or more processors to perform the method 700. In some embodiments, the method 700 includes, causing the one or more cameras of the head-wearable device to capture an image of a field-of-view (e.g., the field-of-view 150 and/or the field-of-view 350) of the user (702). The method 700 further includes causing an eye-tracking device of the head-wearable device to determine a gaze (e.g., the gaze 140 and/or the gaze 340) of the user (704). The method 700 further includes, in response to a capture command (e.g., the voice command 130 and/or the voice command 330), isolating a gaze area of the image from a remainder of the image based on the gaze of the user (706). The method 700 further includes identifying, using a machine-learning algorithm (e.g., the multi-modal AI), an object (e.g., the object of focus 155 and/or the object of focus 355) in the gaze area (708). The method 700 further includes causing a response to be generated, using another machine-learning algorithm (e.g., the multi-modal AI), based on the object (712).
(A2) In some embodiments of A2, the method 700 further includes, after generating the response based on the object, cause the head-wearable device to present the response to the user (714) (e.g., via one or more displays of the head-wearable device 110 and/or one or more speakers of the head-wearable device 110).
(A3) In some embodiments of any of A1-A2, the method 700 further includes, after identifying the object in the gaze area, execute one or more tasks (e.g., generating an answer to a user question) based on the object and/or the capture command (e.g., the capture command including the user question) (710). The response is further based on the one or more tasks.
(A4) In some embodiments of any of A1-A3, the capture command includes a user question associated with the object, the one or more tasks includes generating an answer to the user question, and the response includes the answer to the user question.
(A5) In some embodiments of any of A1-A4, the method 700 further includes, causing the one or more cameras of the head-wearable device to capture another image of the field-of-view (e.g., the field-of-view 150 and/or the field-of-view 350) of the user. The method 700 further includes causing the eye-tracking device to determine another gaze (e.g., the gaze 140 and/or the gaze 340) of the user. The method 700 further includes, in response to another capture command (e.g., the voice command 130 and/or the voice command 330), isolating another gaze area of the other image from a remainder of the other image based on the other gaze of the user. The method 700 further includes identifying, using the machine-learning algorithm (e.g., the multi-modal AI), another object (e.g., the object of focus 155 and/or the object of focus 355) in the other gaze area. The method 700 further includes causing another response to be generated, using the other machine-learning algorithm (e.g., the multi-modal AI), based on the other object.
(A6) In some embodiments of any of A1-A5, causing the camera to capture is in response to a wake command (e.g., the user wake input).
(A7) In some embodiments of any of A1-A6, the capture command and the wake command are a capture/wake command (e.g., causing the camera of the head-wearable device to capture the image of the field-of-view of the user and isolating the gaze area of the image from the remainder of the image based on the gaze of the user are in response to one user input).
(A8) In some embodiments of any of A1-A7, the response is presented to the user at one or more displays of the head-wearable device and/or one or more speakers of the head-wearable device.
(A9) In some embodiments of any of A1-A8, causing the camera to capture the image of the field-of-view of the user and causing the eye-tracking device to determine the gaze of the user are in response to a wake command
(A10) In some embodiments of any of A1-A9, the capture command is one or more of a voice command, a hand gesture, and/or a touch input.
(A11) In some embodiments of any of A1-A10, the response is based on the object and the capture command.
(A12) In some embodiments of any of A1-A11, wherein the eye tracking device of the head-wearable device includes one of an eye-tracking camera and/or a combination of another camera of the head-wearable device to capture another image of the field-of-view of the user and an inertial measurement unit (IMU) sensor of the head-wearable device (e.g., the combination approximates the gaze of the user based on a combination of the other image and IMU data from the IMU sensor).
(A13) In some embodiments of any of A1-A12, a multi-modal artificial intelligence, executed at the one or more processors, includes the machine learning-algorithm and the other machine-learning algorithm.
(A14) In some embodiments of any of A1-A13, isolating a gaze area of the image from a remainder of the image based on the gaze of the user includes cropping the image of the field-of-view of the user to the gaze area.
(A15) In some embodiments of any of A1-A14, identifying the object in the gaze area includes (i) determining respective probabilities that the object is one of a plurality of objects and (ii) determining a respective object has a greatest probability of the plurality of objects.
(B1) Means for performing or causing performance of the operations of any of A1-A12.
(C1) A wearable device (e.g., the head-worn device 110) configured to perform or cause performance of the operations of any of A1-A12.
(D1) A system including one or more wearable devices (e.g., the head-wearable device 110 and/or the wrist-wearable device 126), the system configured to perform or cause performance of the operations of any of A1-A12.
(E1) A method comprising steps corresponding to the operations of any of A1-A12.
(F1) In accordance with some embodiments, head-wearable device (e.g., the head-wearable device 110) comprises: (i) one or more processors, (ii) memory including instructions that, when executed by the one or more processors, determine a gaze of the user using at least one machine-learning algorithm, and (iii) two groups of illumination sources, each group of illumination sources configured to illuminate the respective eye of the user. A first camera and a first group of illumination sources are located on a first circuit. The first camera and the first group of illumination sources are coplanar, and the first camera and the first group of illumination sources are located on a nasal portion of the head-wearable device.
(F2) In some embodiments of F1, the head-wearable device is configured to perform the method 700, as described in any of A1-A12.
(G1) Means for performing or causing performance of the operations of any of F1-F2.
(H1) A system including the head-wearable device of F1 configured to perform or cause performance of the operations of any of F1-F2.
(I1) An intermediary processing device (e.g., configured to offload processing operations for the head-wearable device of F1) configured to perform or cause performance of the operations of any of F1-F2.
(J1) A method comprising steps corresponding to the operations of any of F1-F2.

### Example Extended-Reality Systems

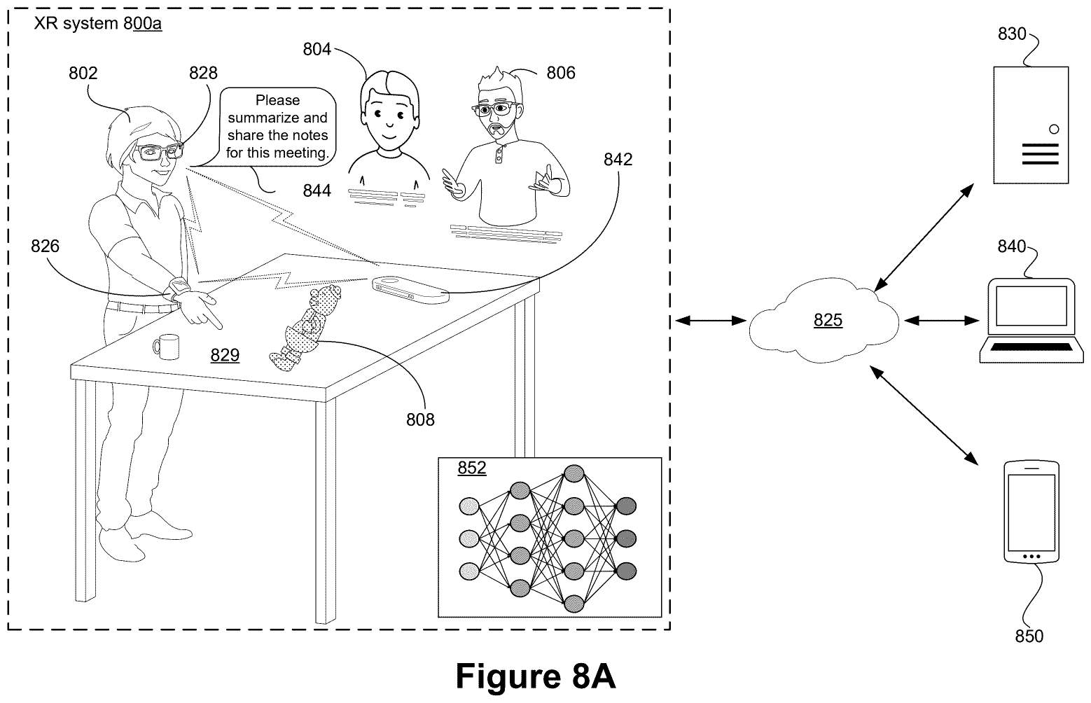

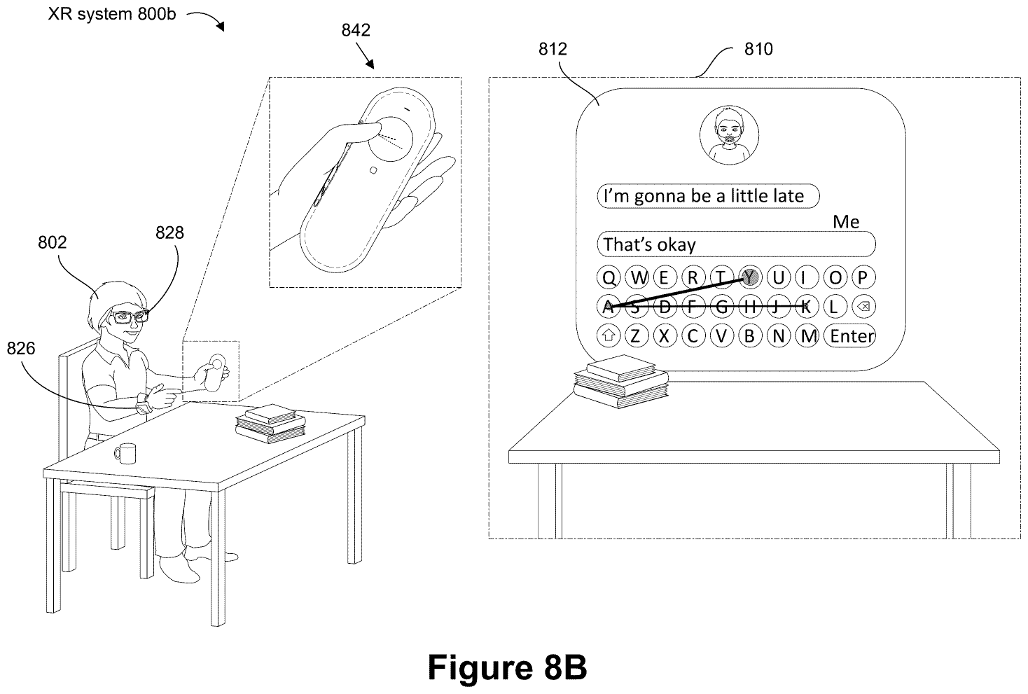

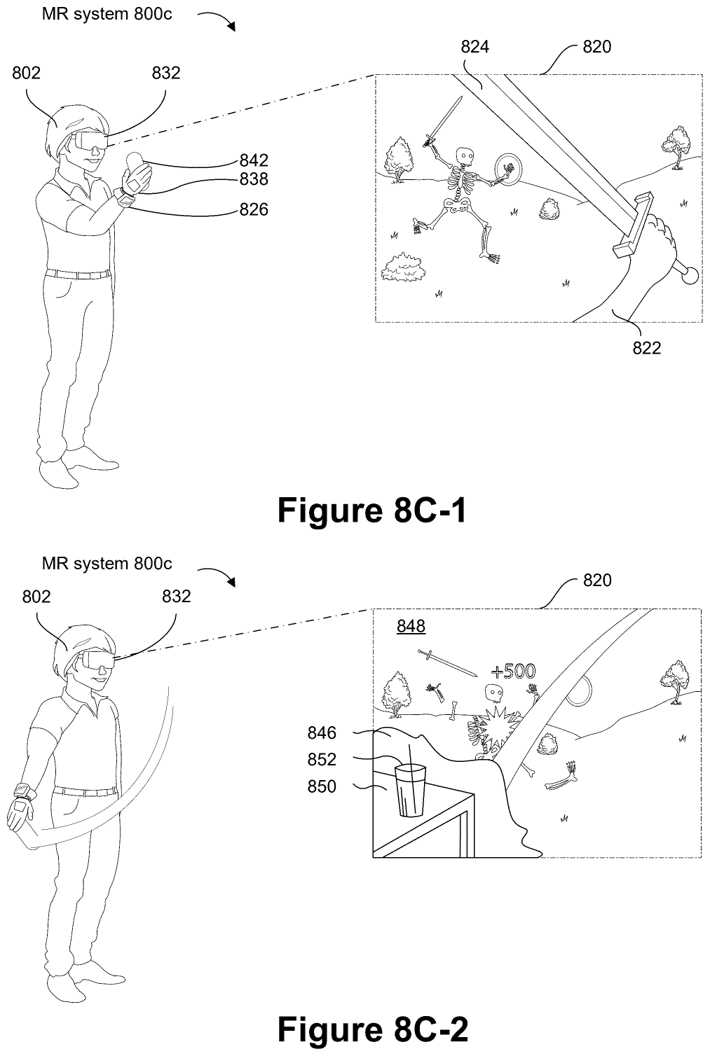

FIGS. 8A 8B, 8C-1, and 8C-2, illustrate example XR systems that include AR and MR systems, in accordance with some embodiments. FIG. 8A shows a first XR system 800a and first example user interactions using a wrist-wearable device 826, a head-wearable device (e.g., AR device 828), and/or a HIPD 842. FIG. 8B shows a second XR system 800b and second example user interactions using a wrist-wearable device 826, AR device 828, and/or an HIPD 842. FIGS. 8C-1 and 8C-2 show a third MR system 800c and third example user interactions using a wrist-wearable device 826, a head-wearable device (e.g., an MR device such as a VR device), and/or an HIPD 842. As the skilled artisan will appreciate upon reading the descriptions provided herein, the above-example AR and MR systems (described in detail below) can perform various functions and/or operations.

The wrist-wearable device 826, the head-wearable devices, and/or the HIPD 842 can communicatively couple via a network 825 (e.g., cellular, near field, Wi-Fi, personal area network, wireless LAN). Additionally, the wrist-wearable device 826, the head-wearable device, and/or the HIPD 842 can also communicatively couple with one or more servers 830, computers 840 (e.g., laptops, computers), mobile devices 850 (e.g., smartphones, tablets), and/or other electronic devices via the network 825 (e.g., cellular, near field, Wi-Fi, personal area network, wireless LAN). Similarly, a smart textile-based garment, when used, can also communicatively couple with the wrist-wearable device 826, the head-wearable device(s), the HIPD 842, the one or more servers 830, the computers 840, the mobile devices 850, and/or other electronic devices via the network 825 to provide inputs.

Turning to FIG. 8A, a user 802 is shown wearing the wrist-wearable device 826 and the AR device 828 and having the HIPD 842 on their desk. The wrist-wearable device 826, the AR device 828, and the HIPD 842 facilitate user interaction with an AR environment. In particular, as shown by the first AR system 800a, the wrist-wearable device 826, the AR device 828, and/or the HIPD 842 cause presentation of one or more avatars 804, digital representations of contacts 806, and virtual objects 808. As discussed below, the user 802 can interact with the one or more avatars 804, digital representations of the contacts 806, and virtual objects 808 via the wrist-wearable device 826, the AR device 828, and/or the HIPD 842. In addition, the user 802 is also able to directly view physical objects in the environment, such as a physical table 829, through transparent lens(es) and waveguide(s) of the AR device 828. Alternatively, an MR device could be used in place of the AR device 828 and a similar user experience can take place, but the user would not be directly viewing physical objects in the environment, such as table 829, and would instead be presented with a virtual reconstruction of the table 829 produced from one or more sensors of the MR device (e.g., an outward facing camera capable of recording the surrounding environment).

The user 802 can use any of the wrist-wearable device 826, the AR device 828 (e.g., through physical inputs at the AR device and/or built-in motion tracking of a user's extremities), a smart-textile garment, externally mounted extremity tracking device, the HIPD 842 to provide user inputs, etc. For example, the user 802 can perform one or more hand gestures that are detected by the wrist-wearable device 826 (e.g., using one or more EMG sensors and/or IMUs built into the wrist-wearable device) and/or AR device 828 (e.g., using one or more image sensors or cameras) to provide a user input. Alternatively, or additionally, the user 802 can provide a user input via one or more touch surfaces of the wrist-wearable device 826, the AR device 828, and/or the HIPD 842, and/or voice commands captured by a microphone of the wrist-wearable device 826, the AR device 828, and/or the HIPD 842. The wrist-wearable device 826, the AR device 828, and/or the HIPD 842 include an artificially intelligent digital assistant to help the user in providing a user input (e.g., completing a sequence of operations, suggesting different operations or commands, providing reminders, confirming a command). For example, the digital assistant can be invoked through an input occurring at the AR device 828 (e.g., via an input at a temple arm of the AR device 828). In some embodiments, the user 802 can provide a user input via one or more facial gestures and/or facial expressions. For example, cameras of the wrist-wearable device 826, the AR device 828, and/or the HIPD 842 can track the user 802's eyes for navigating a user interface.

The wrist-wearable device 826, the AR device 828, and/or the HIPD 842 can operate alone or in conjunction to allow the user 802 to interact with the AR environment. In some embodiments, the HIPD 842 is configured to operate as a central hub or control center for the wrist-wearable device 826, the AR device 828, and/or another communicatively coupled device. For example, the user 802 can provide an input to interact with the AR environment at any of the wrist-wearable device 826, the AR device 828, and/or the HIPD 842, and the HIPD 842 can identify one or more back-end and front-end tasks to cause the performance of the requested interaction and distribute instructions to cause the performance of the one or more back-end and front-end tasks at the wrist-wearable device 826, the AR device 828, and/or the HIPD 842. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 842 can perform the back-end tasks and provide the wrist-wearable device 826 and/or the AR device 828 operational data corresponding to the performed back-end tasks such that the wrist-wearable device 826 and/or the AR device 828 can perform the front-end tasks. In this way, the HIPD 842, which has more computational resources and greater thermal headroom than the wrist-wearable device 826 and/or the AR device 828, performs computationally intensive tasks and reduces the computer resource utilization and/or power usage of the wrist-wearable device 826 and/or the AR device 828.

In the example shown by the first AR system 800a, the HIPD 842 identifies one or more back-end tasks and front-end tasks associated with a user request to initiate an AR video call with one or more other users (represented by the avatar 804 and the digital representation of the contact 806) and distributes instructions to cause the performance of the one or more back-end tasks and front-end tasks. In particular, the HIPD 842 performs back-end tasks for processing and/or rendering image data (and other data) associated with the AR video call and provides operational data associated with the performed back-end tasks to the AR device 828 such that the AR device 828 performs front-end tasks for presenting the AR video call (e.g., presenting the avatar 804 and the digital representation of the contact 806).

In some embodiments, the HIPD 842 can operate as a focal or anchor point for causing the presentation of information. This allows the user 802 to be generally aware of where information is presented. For example, as shown in the first AR system 800a, the avatar 804 and the digital representation of the contact 806 are presented above the HIPD 842. In particular, the HIPD 842 and the AR device 828 operate in conjunction to determine a location for presenting the avatar 804 and the digital representation of the contact 806. In some embodiments, information can be presented within a predetermined distance from the HIPD 842 (e.g., within five meters). For example, as shown in the first AR system 800a, virtual object 808 is presented on the desk some distance from the HIPD 842. Similar to the above example, the HIPD 842 and the AR device 828 can operate in conjunction to determine a location for presenting the virtual object 808. Alternatively, in some embodiments, presentation of information is not bound by the HIPD 842. More specifically, the avatar 804, the digital representation of the contact 806, and the virtual object 808 do not have to be presented within a predetermined distance of the HIPD 842. While an AR device 828 is described working with an HIPD, an MR headset can be interacted with in the same way as the AR device 828.

User inputs provided at the wrist-wearable device 826, the AR device 828, and/or the HIPD 842 are coordinated such that the user can use any device to initiate, continue, and/or complete an operation. For example, the user 802 can provide a user input to the AR device 828 to cause the AR device 828 to present the virtual object 808 and, while the virtual object 808 is presented by the AR device 828, the user 802 can provide one or more hand gestures via the wrist-wearable device 826 to interact and/or manipulate the virtual object 808. While an AR device 828 is described working with a wrist-wearable device 826, an MR headset can be interacted with in the same way as the AR device 828.

Integration of Artificial Intelligence with XR Systems

FIG. 8A illustrates an interaction in which an artificially intelligent virtual assistant can assist in requests made by a user 802. The AI virtual assistant can be used to complete open-ended requests made through natural language inputs by a user 802. For example, in FIG. 8A the user 802 makes an audible request 844 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 8A also illustrates an example neural network 852 used in Artificial Intelligence applications. Uses of Artificial Intelligence (AI) are varied and encompass many different aspects of the devices and systems described herein. AI capabilities cover a diverse range of applications and deepen interactions between the user 802 and user devices (e.g., the AR device 828, an MR device 832, the HIPD 842, the wrist-wearable device 826). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 802 can interact with an AI model through natural language inputs captured by a voice sensor, text inputs, or any other input modality that accepts natural language and/or a corresponding voice sensor module. In another instance, input is provided by tracking the eye gaze of a user 802 via a gaze tracker module. Additionally, the AI model can also receive inputs beyond those supplied by a user 802. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 828) or from multiple devices that are in communication with each other (e.g., a system that includes at least two of an AR device 828, an MR device 832, the HIPD 842, the wrist-wearable device 826, etc.). The AI model can also access additional information (e.g., one or more servers 830, the computers 840, the mobile devices 850, and/or other electronic devices) via a network 825.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 828, an MR device 832, the HIPD 842, the wrist-wearable device 826) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 828, an MR device 832, the HIPD 842, the wrist-wearable device 826), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 842), haptic feedback can provide information to the user 802. An AI model can also use the inputs described above to determine the appropriate modality and device(s) to present content to the user (e.g., a user walking on a busy road can be presented with an audio output instead of a visual output to avoid distracting the user 802).

### Example Augmented Reality Interaction

FIG. 8B shows the user 802 wearing the wrist-wearable device 826 and the AR device 828 and holding the HIPD 842. In the second AR system 800b, the wrist-wearable device 826, the AR device 828, and/or the HIPD 842 are used to receive and/or provide one or more messages to a contact of the user 802. In particular, the wrist-wearable device 826, the AR device 828, and/or the HIPD 842 detect and coordinate one or more user inputs to initiate a messaging application and prepare a response to a received message via the messaging application.

In some embodiments, the user 802 initiates, via a user input, an application on the wrist-wearable device 826, the AR device 828, and/or the HIPD 842 that causes the application to initiate on at least one device. For example, in the second AR system 800b the user 802 performs a hand gesture associated with a command for initiating a messaging application (represented by messaging user interface 812); the wrist-wearable device 826 detects the hand gesture; and, based on a determination that the user 802 is wearing the AR device 828, causes the AR device 828 to present a messaging user interface 812 of the messaging application. The AR device 828 can present the messaging user interface 812 to the user 802 via its display (e.g., as shown by user 802's field of view 810). In some embodiments, the application is initiated and can be run on the device (e.g., the wrist-wearable device 826, the AR device 828, and/or the HIPD 842) that detects the user input to initiate the application, and the device provides another device operational data to cause the presentation of the messaging application. For example, the wrist-wearable device 826 can detect the user input to initiate a messaging application, initiate and run the messaging application, and provide operational data to the AR device 828 and/or the HIPD 842 to cause presentation of the messaging application. Alternatively, the application can be initiated and run at a device other than the device that detected the user input. For example, the wrist-wearable device 826 can detect the hand gesture associated with initiating the messaging application and cause the HIPD 842 to run the messaging application and coordinate the presentation of the messaging application.

Further, the user 802 can provide a user input provided at the wrist-wearable device 826, the AR device 828, and/or the HIPD 842 to continue and/or complete an operation initiated at another device. For example, after initiating the messaging application via the wrist-wearable device 826 and while the AR device 828 presents the messaging user interface 812, the user 802 can provide an input at the HIPD 842 to prepare a response (e.g., shown by the swipe gesture performed on the HIPD 842). The user 802's gestures performed on the HIPD 842 can be provided and/or displayed on another device. For example, the user 802's swipe gestures performed on the HIPD 842 are displayed on a virtual keyboard of the messaging user interface 812 displayed by the AR device 828.

In some embodiments, the wrist-wearable device 826, the AR device 828, the HIPD 842, and/or other communicatively coupled devices can present one or more notifications to the user 802. The notification can be an indication of a new message, an incoming call, an application update, a status update, etc. The user 802 can select the notification via the wrist-wearable device 826, the AR device 828, or the HIPD 842 and cause presentation of an application or operation associated with the notification on at least one device. For example, the user 802 can receive a notification that a message was received at the wrist-wearable device 826, the AR device 828, the HIPD 842, and/or other communicatively coupled device and provide a user input at the wrist-wearable device 826, the AR device 828, and/or the HIPD 842 to review the notification, and the device detecting the user input can cause an application associated with the notification to be initiated and/or presented at the wrist-wearable device 826, the AR device 828, and/or the HIPD 842.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 828 can present to the user 802 game application data and the HIPD 842 can use a controller to provide inputs to the game. Similarly, the user 802 can use the wrist-wearable device 826 to initiate a camera of the AR device 828, and the user can use the wrist-wearable device 826, the AR device 828, and/or the HIPD 842 to manipulate the image capture (e.g., zoom in or out, apply filters) and capture image data.

While an AR device 828 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 8C-1 and 8C-2, the user 802 is shown wearing the wrist-wearable device 826 and an MR device 832 (e.g., a device capable of providing either an entirely VR experience or an MR experience that displays object(s) from a physical environment at a display of the device) and holding the HIPD 842. In the third AR system 800c, the wrist-wearable device 826, the MR device 832, and/or the HIPD 842 are used to interact within an MR environment, such as a VR game or other MR/VR application. While the MR device 832 presents a representation of a VR game (e.g., first MR game environment 820) to the user 802, the wrist-wearable device 826, the MR device 832, and/or the HIPD 842 detect and coordinate one or more user inputs to allow the user 802 to interact with the VR game.

In some embodiments, the user 802 can provide a user input via the wrist-wearable device 826, the MR device 832, and/or the HIPD 842 that causes an action in a corresponding MR environment. For example, the user 802 in the third MR system 800c (shown in FIG. 8C-1) raises the HIPD 842 to prepare for a swing in the first MR game environment 820. The MR device 832, responsive to the user 802 raising the HIPD 842, causes the MR representation of the user 822 to perform a similar action (e.g., raise a virtual object, such as a virtual sword 824). In some embodiments, each device uses respective sensor data and/or image data to detect the user input and provide an accurate representation of the user 802's motion. For example, image sensors (e.g., SLAM cameras or other cameras) of the HIPD 842 can be used to detect a position of the HIPD 842 relative to the user 802's body such that the virtual object can be positioned appropriately within the first MR game environment 820; sensor data from the wrist-wearable device 826 can be used to detect a velocity at which the user 802 raises the HIPD 842 such that the MR representation of the user 822 and the virtual sword 824 are synchronized with the user 802's movements; and image sensors of the MR device 832 can be used to represent the user 802's body, boundary conditions, or real-world objects within the first MR game environment 820.

In FIG. 8C-2, the user 802 performs a downward swing while holding the HIPD 842. The user 802's downward swing is detected by the wrist-wearable device 826, the MR device 832, and/or the HIPD 842 and a corresponding action is performed in the first MR game environment 820. In some embodiments, the data captured by each device is used to improve the user's experience within the MR environment. For example, sensor data of the wrist-wearable device 826 can be used to determine a speed and/or force at which the downward swing is performed and image sensors of the HIPD 842 and/or the MR device 832 can be used to determine a location of the swing and how it should be represented in the first MR game environment 820, which, in turn, can be used as inputs for the MR environment (e.g., game mechanics, which can use detected speed, force, locations, and/or aspects of the user 802's actions to classify a user's inputs (e.g., user performs a light strike, hard strike, critical strike, glancing strike, miss) or calculate an output (e.g., amount of damage)).

FIG. 8C-2 further illustrates that a portion of the physical environment is reconstructed and displayed at a display of the MR device 832 while the MR game environment 820 is being displayed. In this instance, a reconstruction of the physical environment 846 is displayed in place of a portion of the MR game environment 820 when object(s) in the physical environment are potentially in the path of the user (e.g., a collision with the user and an object in the physical environment are likely). Thus, this example MR game environment 820 includes (i) an immersive VR portion 848 (e.g., an environment that does not have a corollary counterpart in a nearby physical environment) and (ii) a reconstruction of the physical environment 846 (e.g., table 850 and cup 852). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 826, the MR device 832, and/or the HIPD 842 are described as detecting user inputs, in some embodiments, user inputs are detected at a single device (with the single device being responsible for distributing signals to the other devices for performing the user input). For example, the HIPD 842 can operate an application for generating the first MR game environment 820 and provide the MR device 832 with corresponding data for causing the presentation of the first MR game environment 820, as well as detect the user 802's movements (while holding the HIPD 842) to cause the performance of corresponding actions within the first MR game environment 820. Additionally or alternatively, in some embodiments, operational data (e.g., sensor data, image data, application data, device data, and/or other data) of one or more devices is provided to a single device (e.g., the HIPD 842) to process the operational data and cause respective devices to perform an action associated with processed operational data.

In some embodiments, the user 802 can wear a wrist-wearable device 826, wear an MR device 832, wear smart textile-based garments 838 (e.g., wearable haptic gloves), and/or hold an HIPD 842 device. In this embodiment, the wrist-wearable device 826, the MR device 832, and/or the smart textile-based garments 838 are used to interact within an MR environment (e.g., any AR or MR system described above in reference to FIGS. 8A-8B). While the MR device 832 presents a representation of an MR game (e.g., second MR game environment 820) to the user 802, the wrist-wearable device 826, the MR device 832, and/or the smart textile-based garments 838 detect and coordinate one or more user inputs to allow the user 802 to interact with the MR environment.

In some embodiments, the user 802 can provide a user input via the wrist-wearable device 826, an HIPD 842, the MR device 832, and/or the smart textile-based garments 838 that causes an action in a corresponding MR environment. In some embodiments, each device uses respective sensor data and/or image data to detect the user input and provide an accurate representation of the user 802's motion. While four different input devices are shown (e.g., a wrist-wearable device 826, an MR device 832, an HIPD 842, and a smart textile-based garment 838) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 838) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 838 can be used in conjunction with an MR device and/or an HIPD 842.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 8A-8C-2 provided above are intended to augment the description provided in reference to FIGS. 1-7. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
while a head-wearable device is worn by a user:
cause a camera of the head-wearable device to capture an image of a field-of-view of the user;
determine a gaze of the user based on eye-tracking data captured at an eye-tracking device of the head-wearable device;
in response to a capture command, isolate a gaze area of the image from a remainder of the image based on the gaze of the user;
identify, using a machine-learning algorithm, an object in the gaze area; and
cause a response, based on the object, to be generated by another machine-learning algorithm.

2. The non-transitory, computer-readable storage medium of claim 1, wherein the executable instructions further cause the head-wearable device to:
while the head-wearable device is worn by the user:
after causing the response to be generated, cause the head-wearable device to present the response to the user.

3. The non-transitory, computer-readable storage medium of claim 1, wherein the executable instructions further cause the head-wearable device to:
while the head-wearable device is worn by the user:
after identifying the object in the gaze area, execute one or more tasks based on at least one of the object and the capture command, wherein the response is further based on the one or more tasks.

4. The non-transitory, computer-readable storage medium of claim 3, wherein:
the capture command includes a user question associated with the object;
the one or more tasks includes generating an answer to the user question; and
the response includes the answer to the user question.

5. The non-transitory, computer-readable storage medium of claim 1, wherein the executable instructions further cause the head-wearable device to:
while the head-wearable device is worn by the user:
cause the camera to capture another image of the field-of-view of the user;
determine another gaze of the user based on the eye-tracking data captured at the eye-tracking device;
in response to another capture command, isolate another gaze area of the other image from a remainder of the other image based on the other gaze of the user;
identify, using the machine-learning algorithm, another object in the other gaze area; and
cause another response, based on the other object, to be generated by the other machine-learning algorithm.

6. The non-transitory, computer-readable storage medium of claim 1, wherein causing the camera to capture is in response to a wake command.

7. The non-transitory, computer-readable storage medium of claim 6, wherein the capture command and the wake command are a capture/wake command.

8. The non-transitory, computer-readable storage medium of claim 1, wherein the response is presented to the user at one or more of one or more displays of the head-wearable device and one or more speakers of the head-wearable device.

9. The non-transitory, computer-readable storage medium of claim, wherein the capture command is one or more of a voice command, a hand gesture, and a touch input.

10. The non-transitory, computer-readable storage medium of claim 1, wherein the eye tracking device of the head-wearable device includes one or more of an eye-tracking camera and a combination of another camera of the head-wearable device to capture another image of the field-of-view of the user and an inertial measurement unit (IMU) sensor of the head-wearable device.

11. The non-transitory, computer-readable storage medium of claim 1, wherein a multi-modal artificial intelligence, executed at the one or more processors, includes the machine learning-algorithm and the other machine-learning algorithm.

12. The non-transitory, computer-readable storage medium of claim 1, wherein isolating a gaze area of the image from a remainder of the image based on the gaze of the user includes cropping the image of the field-of-view of the user to the gaze area.

13. The non-transitory, computer-readable storage medium of claim 1, wherein identifying the object in the gaze area includes:
determining respective probabilities that the object is one of a plurality of objects; and
determining a respective object has a greatest probability of the plurality of objects.

14. A method comprising:
while a head-wearable device is worn by a user:
capturing an image of a field-of-view of the user at a camera of the head-wearable device;
determining a gaze of the user based on eye-tracking data captured at an eye-tracking device of the head-wearable device;
in response to a capture command, isolating a gaze area of the image from a remainder of the image based on the gaze of the user;
identifying, using a machine-learning algorithm, an object in the gaze area; and
generating a response, by another machine-learning algorithm, based on the object.

15. The method of claim 14, further comprising:
while the head-wearable device is worn by the user:
after generating the response based on the object, presenting the response to the user and the head-wearable device.

16. The method of claim 14, further comprising:
while the head-wearable device is worn by the user:
after identifying the object in the gaze area, executing one or more tasks based on at least one of the object and the capture command, wherein the response is further based on the one or more tasks.

17. The method of claim 14, further comprising:
capturing another image of a field-of-view of the user at the camera;
determining another gaze of the user based on the eye-tracking data captured at an eye-tracking device;
in response to another capture command, isolating another gaze area of the other image from a remainder of the other image based on the other gaze of the user;
identifying, using the machine-learning algorithm, another object in the other gaze area; and
generating another response, by the other machine-learning algorithm, based on the other object.

18. A head-wearable device including a camera and an eye-tracking device, the head-wearable device configured to:
while the head-wearable device is worn by a user:
capture an image of a field-of-view of the user at the camera;
cause a gaze of the user to be determined based on eye-tracking data captured at the eye-tracking device;
in response to a capture command, cause a gaze area of the image to be isolated from a remainder of the image based on the gaze of the user;
cause a machine-learning algorithm to identify an object in the gaze area; and
present a response, generated by another machine-learning algorithm, to the user based on the object.

19. The head-wearable device of claim 18, further configured to:
while the head-wearable device is worn by the user:
after causing the object to be identified in the gaze area, execute one or more tasks based on at least one of the object and the capture command, wherein the response is further based on the one or more tasks.

20. The head-wearable device of claim 18, further configured to:
while the head-wearable device is worn by a user:
capture another image of the field-of-view of the user at the camera;
cause another gaze of the user to be determined based on the eye-tracking data captured at the eye-tracking device;
in response to another capture command, cause another gaze area of the other image to be isolated from a remainder of the other image based on the other gaze of the user;
cause the machine-learning algorithm to identify another object in the other gaze area; and
present another response, generated by the other machine-learning algorithm, to the user based on the other object.
